(19) United States
(12) Patent Application Publication
(10) Pub. No.: US 2012/0186538 A1
(43) Pub. Date: Jul. 26, 2012

(54) Roam safely dog leash

(76) Inventor: William Timothy Newton, Knoxville, TN (US)

(21) Appl. No.: 13/373,053

(22) Filed: Nov. 3, 2011

Related U.S. Application Data
(60) Provisional application No. 61/458,679, filed on Nov. 29, 2010.

(51) Int. Cl. A01K 27/00

(52) U.S. Cl. 119/795

(57) ABSTRACT

A leash is described allowing a handler to safely and comfortably lead a dog through normal surroundings and conditions requiring close control of the dog. The handler may keep undivided attention on the prevailing circumstances when acquiring and releasing close control of the dog. A short leash is placed so the handler can quickly slide a hand down a plastic coated steel cable to grasp the short leash handle without looking down or slowing pace. Elastic chord provides cushioning between handler and dog. Overall length of the leash is such that the dog will be prevented from being tangled with the leash. The leash can be carried in a pocket or purse due to its being light and compact.

There are many types of dog leashes. The most of them comprise webbing or leather strips with a loop sowed on one end as a handle, and a snap-hook at the other end. These leashes provide for walking dogs only under normal nonhazardous conditions. Retractable leashes, such as Doctors Foster and Smith's “Walk-n-Lead,” have the disadvantage that they will not retract under tension when the dog pulls, causing considerable time and effort to regain close control of the dog. Double handle leashes of Culp and Kraus address the control issue. Kraus provides a looped handle at one end of a webbing strip and a looped short leash handle close to the leash connection on the dog's collar. The short leash handle hangs beneath the webb strip in a position requiring extra effort and time to reach. The handler will have to turn loose of the outer handle in order to reach and grasp the short leash handle. Another disadvantage of the Culp and Kraus leashes is that one incident requiring use of the short leash causes two interruptions of the walk. The Culp and Kraus leashes provide no cushioning between dog and handler.

The leash of Irbinskas contains a choke type dog collar to control the dog, which many trainers consider abusive to dogs. The leashes of Irbinskas, McPhail, and Livesay are constructed with webbing and have no provision for close control of the dog. The waist connected leash for runners of McDonough, while having a midway looped webbing handle, is intended for runners. Leather or webbing used by the above dogs is bulky, subject to water damage and odor, is easily tangled, and may be damaged by the dog chewing on it. Elastic cord used with the above leashes is in a place subject to chewing damage.

### SUMMARY

In accordance with one embodiment, an improved dog leash comprising a rigid handle supported by an elastic cord which is connected to a cable. The cable is attached by a snap-hook to a steel ring on the rigid handle of a short leash that is attached by a snap-hook to the leash ring of the dog's collar.

### DRAWING FIGURES

In the drawings, closely related figures have the same number but different alphabetic suffixes.

FIG. 1A shows the leash upper section cable snap-hook attached to the short leash handle steel ring as being used under normal conditions.

FIG. 1B shows the leash of FIG. 1A as used under close control conditions.

FIG. 1C shows the short leash of FIG. 1A detached as used under close control conditions.

FIG. 2A shows the leash upper section cable connected directly to the short leash handle steel ring as used under normal conditions.

FIG. 2B shows the leash of FIG. 2A as used under close control conditions.

FIG. 3A shows the leash upper section cable snap-hook attached directly to the short leash handle.

FIG. 3B shows the leash of FIG. 3A as used under close control conditions.

FIG. 3C shows the short leash of FIG. 3A detached as used under close control conditions.

FIG. 4A shows the leash with the upper section permanently connected to the short leash handle as used during normal conditions.

FIG. 4B shows the leash of FIG. 4A as used during close control conditions.

Drawings—Reference Numbers

10 cylindrical rod
12 steel pins
14 elastic cord
16 upper section cable
18 plastic tubing
20a, 20b snap-hook
22 steel ring
24 short leash cable
26 short leash handle plastic tube
28a, 28b, 28c, 28d clamp-on sleeve

### DETAILED DESCRIPTION

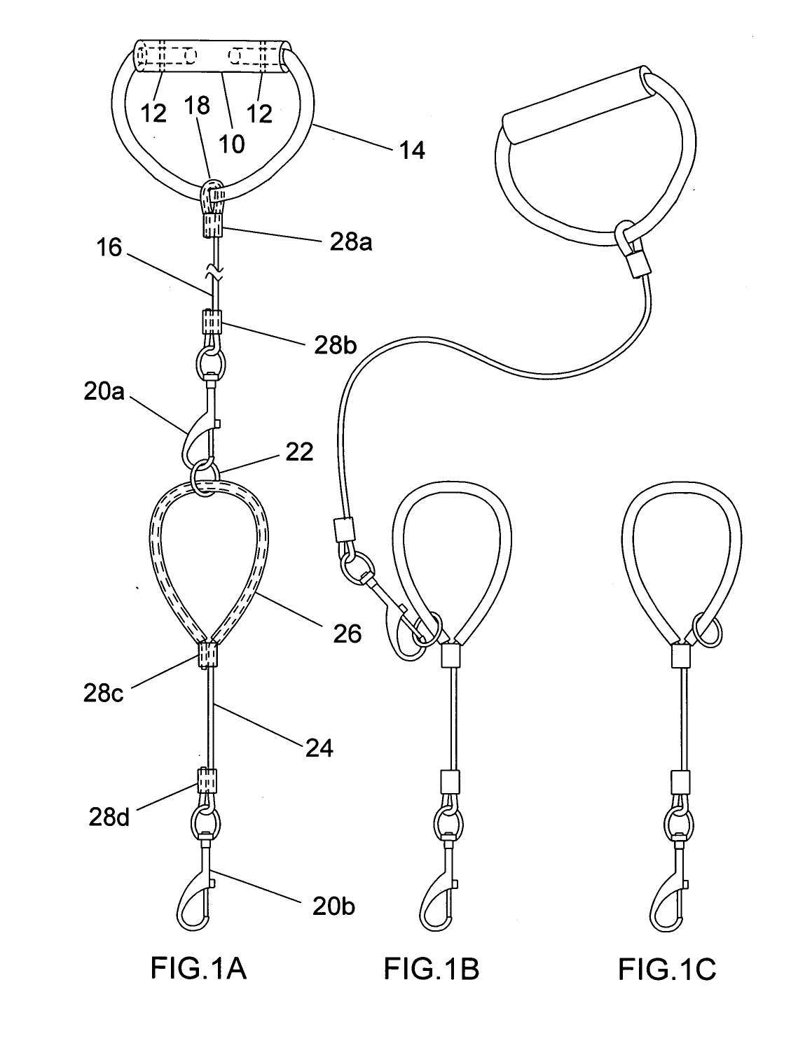

### FIGS. 1A, 1B, and 1C

### First Embodiment

One embodiment of the leash is shown in FIG. 1A, 1B, and 1C. The leash is comprised of an upper section handle made of a cylindrical rod 10 having holes drilled on the center line at each end. Ends of an elastic cord 14 are inserted into the holes to form a D shape. The elastic cord ends are held in place using steel pins 12. An upper section cable 16 is connected to the center of the elastic cord and secured by clamp-on sleeve 28a. The elastic cord is protected from damage by plastic tubing 18. Opposite end of cable is secured by clamp-on sleeve 28b to upper section snap-hook 20a. Snap-hook 20a is attached to steel ring 22 on short leash handle plastic tube 26. A short leash handle is formed by short leash cable 24, threaded through the short leash handle tube and steel ring then formed into a rigid teardrop shape and secured by clamp-on sleeve 28c. A short leash is formed by extending one end of the short leash cable to snap-hook 20b, secured by clamp-on sleeve 28d. Snap-hook 20b is to be attached to dog's collar leash ring. FIG. 1B shows the leash in close control mode. Distance between upper section handle and the short leash handle is selected so the short leash handle can be grasped with one hand while the other hand holds the upper section handle with the leash in tension. Short leash length is selected for close control of the dog. Overall length of the leash should allow ample room for the dog's movements while avoiding the dog being tangled with the leash. Dimensions and cable size will vary to accommodate different size and weight dogs. FIG. 1C shows the short leash disconnected for continuous control of the dog. Plastic coated steel cable is used for its light weight, small size, and resistance to tangling, water and chewing.

### Operation—FIGS. 1A, FIG. 1B, and FIG. 1C

The short leash snap-hook is to be attached to the collar leash ring of the dog. FIGS. 1A, 1B, and 1C are illustrations of modes of operation of the leash. FIG. 1A shows the leash as used under normal operating conditions. The upper section handle of the leash is held by the handler. FIG. 1B shows the leash as used when close control of the dog is necessary. While holding upper section handle in one hand, the other hand grasps the short leash handle at the middle part of the figure. When close control is no longer needed, the handler simply releases the short leash handle, as the upper section handle continues to be held. The leash is constructed so when the leash is in tension, the short leash handle is easily reached while the handler is still grasping the upper section handle with the other hand. These procedures can be done quickly while the handler continues to walk or run. When the short leash is grasped, the ring connection at the top of the short leash handle drops down so the handler will have full use of the handle as shown in FIG. 1B. When the short leash handle is released, the ring connection will return to its place at the top of the handle. While in close control mode, both handles may be held in one hand. FIG. 1C shows the short leash disconnected from the upper section so it can be used alone when close control is needed at all times.

### Additional Embodiments—FIGS. 2A, 3A, and 4A

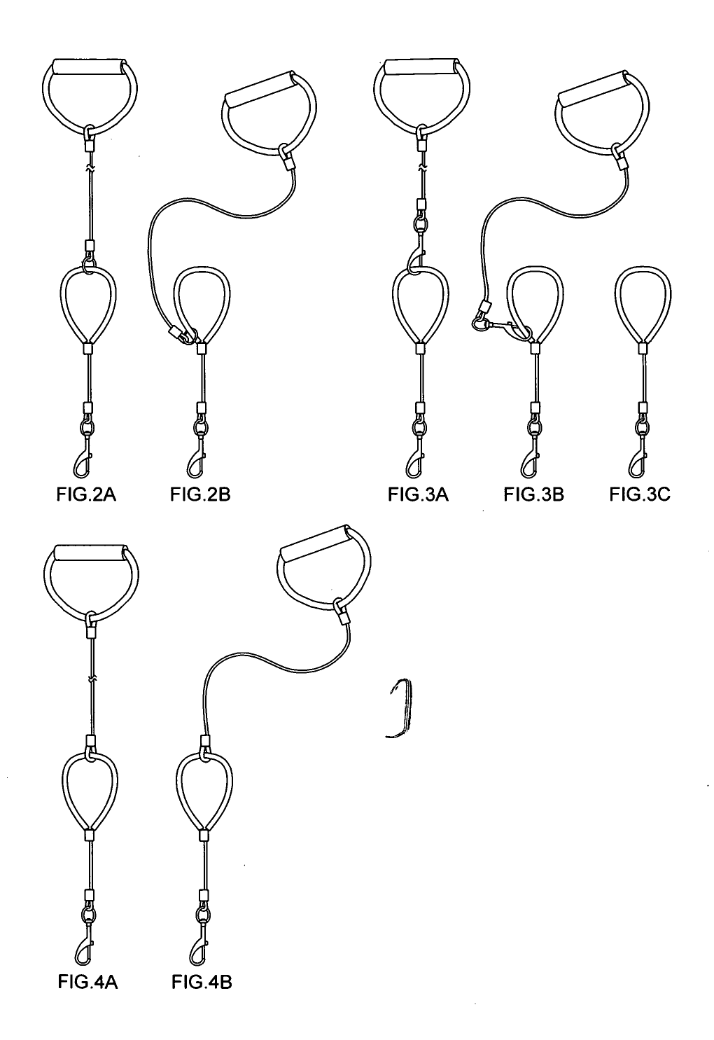

There are various possibilities with regard to the connection of the short leash to the upper section cable of the leash. Additional embodiments are shown in FIGS. 2A, 3A, and 4A. In FIG. 2A the upper section cable is connected to a steel ring on the handle of the short leash. In FIG. 3A the upper section cable is connected to a snap-hook. The snap-hook is attached directly to the handle of the short leash. In FIG. 4A the upper section cable of the leash is connected directly to the handle of the short leash. FIGS. 2B, 3B, 3C, and 4B show close control modes of the embodiments.

### Advantages

From the description above, some advantages of the embodiment of the leash become evident:
(a) The leash allows a dog to be handled safely with ease no matter what the circumstances are.
(b) The short leash is always available when needed. The handler may grasp the short leash in an instant when the need arises.
(c) When the short leash handle is grasped, the ring connection at the top of the handle will automatically drop down so the handler will have full use of the handle. When the short leash is released, the ring connection will return to its place at the top of the short leash handle.
(d) The leash is constructed so that the normally used upper leash handle may always be held in a hand, including the times when the short leash is used. Therefore when the short leash use is no longer necessary, the handler simply lets it go.
(e) When the short leash is needed to be used for an extended period, as in shopping in a store or getting through a crowd of people, both handles may be held comfortably in one hand. The short leash handle may be let go easily without releasing the upper section handle.
(f) Plastic coated steel cable is used, as compared to webbing or leather materials, for its resistance to a dog's chewing on it, superior strength, light weight, small size, resistance to tangling, and resistance to water and odor. The leash may be carried in a pocket or purse due to its light weight and small cable size.
(g) The short leash handle is placed at a distance allowing the handler to continue holding the upper section handle with one hand while grasping and using the short leash handle with the other hand.
(h) Both upper section handle and short leash handle are rigid so as to be easy to grasp and comfortable to the hand.
(i) This leash is an excellent choice for runners and their dogs; the advantage being that there is no need for them to stop or slow down when encountering a hazard. The short leash handle is in an ideal position to be easily grasped. The runner can simply slide a hand down the cable to locate and grasp the short leash handle without looking down. The runner's full attention can remain on the hazard. The short leash handle can be released when the hazard is passed as the upper handle is still in hand.
(j) An elastic cord is included in the upper handle assembly for cushioning between handler and dog and located where chewing damage is unlikely.
(k) Overall length of leash is such to prevent dogs from being tangled with the leash.

### CONCLUSION, RAMIFICATIONS, AND SCOPE

Accordingly, the reader will see that, according to one embodiment of the invention, I have provided a leash for handling a dog safely under various conditions such as crossing busy streets, encountering handlers with unruly dogs, in crowded places, in buildings, along roads without sidewalks, sudden dangers, etc. For close control, a short leash may be brought into use in an instant while the normally used handle continues to be held as a precaution. As soon as the distraction is passed, normal control can be restored instantly by releasing the short leash handle, as the upper leash handle is always in hand. Thus, the handler can safely continue moving without interruption when passing a hazardous situation.

Both handles are rigid and shaped so that both may be held safely in one hand if the handler needs a free hand. In such a case, the short leash can safely be released without releasing the upper leash handle so that the upper leash is immediately again in control.

Plastic coated steel cable, which has the advantages given in (f) above, replaces normally used webbing or leather.

While the above description contains many specificities, these should not be construed as limitations on the scope of any embodiment, but as exemplifications of various embodiments. For example, another cable with a snap-hook attached can be added to the short leash handle thus allowing two dogs to be walked and controlled by a single leash. The short leash handle then provides close control of both dogs.

Thus the scope should be determined by the appended claims and their legal equivalents, and not by the examples given.

I claim:

1. A two handle dog leash having an upper section and lower section comprising:

2. The two handle dog leash of claim 1 wherein having an upper section handle comprising a cylindrical rod, being connected at each end to each end of an elastic cord forming a D shape.

3. The two handle dog leash of claim 2 wherein said upper section comprising:
said upper section handle, connected at center of said elastic cord to an upper section cable having a snap-hook connected to its other end.

4. The two handle dog leash of claim 3 wherein said lower section comprising:
(a) a short leash having a rigid teardrop shaped handle formed by a short leash cable, threaded through a short leash handle plastic tube and steel ring,
(b) one end of said short leash cable extended and connected to a snap-hook.

5. The two handle dog leash of claim 4 wherein a complete leash is formed by upper section snap-hook being attached to said steel ring.

6. The two handle dog leash of claim 5 wherein short leash snap-hook is attached to a collar leash ring of a dog,
thereby when a hazard is encountered, a handler's hand may quickly slide down said upper section cable to grasp the short leash handle, thus said dog can be controlled safely and comfortably without the handler or runner having to look down or slow pace while keeping full attention on the prevailing circumstances.

7. A method of determining various leash dimensions comprising:
(a) distance required between upper leash handle and short leash handle is determined by the distance required to allow the handler to take hold of said short leash handle while continuing to hold said upper leash handle with the other hand, while said leash is in tension,
(b) overall length of the short leash is determined by the length required to keep a dog close and under control,
(c) overall length of said leash should allow ample room for the dog's movements while preventing said dog from being tangled with the leash when said dog is not being watched,
(d) dimensions and cable size may be varied to accommodate different size and weight dogs.

8. A two handle dog leash comprising:
(a) an upper section having a handle supported at each end by an elastic cord, forming a D shape,
(b) center of said elastic chord connected to a cable having an upper section snap-hook on the far end,
(c) a rigid teardrop shaped short leash handle connected by a cable to a snap-hook.

9. The two handle dog leash of claim 8 wherein a complete leash is formed by attaching said upper section snap-hook to a steel ring connection on said short leash handle,
thereby when said short leash handle is grasped, said steel ring connection drops down so the handler will have full use of said short leash handle; then when said short leash handle is released, the ring connection will return to top of said short leash handle.
